(19) United States
(12) Patent Application Publication
(10) Pub. No.: US 2009/0199121 A1
(43) Pub. Date: Aug. 6, 2009

(54) MEDICAL SUPPORT CONTROL SYSTEM

(76) Inventors: Kiyoshi SEKIGUCHI, Tokyo (JP); Masaru ITO, Yokohama (JP); Koichi TASHIRO, Sagamihara (JP); Masahide YAMAKI, Tokyo (JP); Nobuyuki FURUKAWA, Tokyo (JP)

Correspondence Address: OSTROLENK FABER GERB & SOFFEN, 1180 AVENUE OF THE AMERICAS, NEW YORK, NY, 100368403, US

(21) Appl. No.: 12/025,922

(22) Filed: Feb. 5, 2008

(51) Int. Cl. G06F 3/048

(52) U.S. Cl. 715/771

(57) ABSTRACT

A medical support control system, comprising: a first controller connected to at least one device; a second controller connected to at least one device, connected to a network, and provided in a medical environment different from that of the first controller; a manipulation display device shared by the first and second controllers and alternately displaying a first GUI created by the first controller and a second GUI created by the second controller, wherein: if a prescribed report is received via the network or from the prescribed connected device while the first GUI is being displayed, a symbol indicating that the report has been received is displayed on the first GUI, and when the symbol is pressed, the first GUI is switched to a prescribed window of the second GUI corresponding to the report, and a process corresponding to the report is performed by the second controller.

### BACKGROUND OF THE INVENTION

1. Field of the Invention

The present invention relates to a medical support control system for controlling medical devices and non-medical devices used for operations.

2. Description of the Related Art

Operating systems using medical controllers or the like for controlling medical devices such as endoscopes or the like used for operations have been proposed. Medical devices to be controlled such as electric knives, insufflation unit devices, endoscope cameras, light source devices, or the like are connected to the medical controller (also referred to as MC). Also, a display device, a manipulation panel, or the like is connected to the MC. The manipulation panel includes a display unit and a touch sensor, and is used as a central manipulation device by nurses or the like working in an unsterilized area. The display device is used for displaying endoscope images or the like.

There is audio-visual equipment in the operating room such as a room light, a room camera, an interphone device, a liquid crystal display device, or the like (non-medical devices). The audio-visual equipment is controlled independently or by a non-medical controller (also referred to as an NMC) used for the central control.

Japanese Patent Application Publication No. 2006-000536, for example, discloses an operating system, comprising:

a first controller connected to a medical device provided in an operating room;

a second controller connected to a non-medical device provided in the operating room; and

manipulation instruction input means transmitting the content of a manipulation instruction to the first controller when a manipulation instruction for the medical device or the non-medical device is input. The first controller transmits to the second controller a first control signal in accordance with the manipulation instruction of the non-medical device input into the manipulation instruction means. The second controller converts the first control signal into a second control signal used for controlling the non-medical device, and transmits the second control signal to the non-medical device. Thereby, the operating system and a non-medical system work together, and the operating person himself/herself or the like can manipulate the non-medical devices.

### SUMMARY OF THE INVENTION

A medical support control system according to the present invention is a system that comprises:

a first controller connected to at least one device;

a second controller connected to at least one device, connected to a network, and provided in a medical environment different from that of the first controller; and

a manipulation display device shared by the first and second controllers and alternately displaying a first graphical user interface (first GUI) created by the first controller and a second graphical user interface (second GUI) created by the second controller, wherein:

if a prescribed report is received via the network or from the prescribed connected device while the first GUI is being displayed on the manipulation display device, a symbol indicating that the report has been received is displayed on the first GUI, and when the symbol is pressed, the first GUI is switched to a prescribed window of the second GUI corresponding to the report, and a process corresponding to the report is performed by the second controller.

### BRIEF DESCRIPTION OF THE DRAWINGS

FIG. 1 shows an entire configuration of the medical device control system according to the present embodiment;

FIG. 2 is a block diagram showing an entire configuration of a medical support control system 100 according to the present embodiment;

FIG. 3 is a block diagram showing a configuration of a NMC 202 according to the present embodiment;

FIG. 4 shows an example of a setting environment for an MC 114 and the NMC 202 according to the present embodiment;

FIG. 5 shows switching operation of the control target of a TP control switching unit 305 performed between the NMC 202 and the MC 114;

FIG. 6 shows an example of a display window (first GUI) of a touch panel (TP_{MC}) when the MC 114 side is the control target;

FIG. 7 shows an example of a telephone conversation window (second GUI) of the touch panel (TP_{NMC}) displayed when the NMC 202 side is the control target;

FIG. 8 is a flowchart for switching of the control target performed by the TP control switching unit 305 between the MC 202 and the MC 114;

FIG. 9 shows a switching operation from a window of the MC 114 side to a window of the NMC 202 side performed when e-mails are received while the window of the MC 114 side is being displayed according to the present embodiment (variation 1);

FIG. 10 is a flowchart for switching of the control target between the NMC 202 and the MC 114 performed by the TP control switching unit 305 according to the present embodiment (variation 1);

FIG. 11 shows switching to a window of the NMC 202 side performed when there is no more free space in a storage medium while a window of the MC 114 side is being displayed according to the present embodiment (variation 2); and

FIG. 12 is a flowchart for switching of a control target between the NMC 202 and the MC 114 performed by the TP control switching unit 305 according to the present embodiment (variation 2).

### DESCRIPTION OF THE PREFERRED EMBODIMENTS

Hereinafter, the embodiments of the present invention will be explained in detail, referring to the drawings.

A medical support control system according to the present embodiment includes a medical device control system and a non-medical device control system. The medical device control system includes a plurality of medical devices and a medical controller for controlling these medical devices. The non-medical device control system includes non-medical devices (that may further include medical devices) that are used for operations, and a non-medical controller for controlling these non-medical devices.

An endoscopic operating system will be explained as an example of the medical device control system.

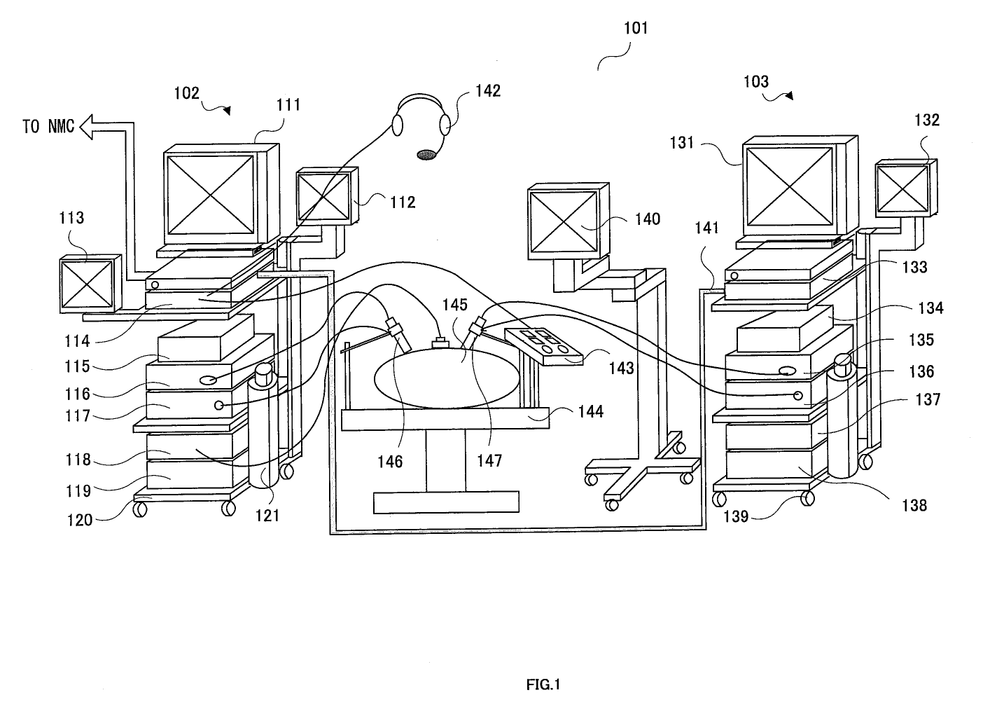

FIG. 1 shows an entire configuration of the medical device control system according to the present embodiment. An endoscopic operating system is shown as a medical device control system 101. In the operating room, a first endoscopic operating system 102 and a second endoscopic operating system 103 beside a bed 144 on which a patient 145 is laid and a wireless remote controller 143 for the operating person are provided.

The endoscopic operating systems 102 and 103 respectively have first and second trolleys 120 and 139 each including a plurality of endoscope peripheral devices used for observation, examination, procedures, recoding, and the like. Also, an endoscope image display panel 140 is arranged on a movable stand.

On the first trolley 120, an endoscope image display panel 111, a central display panel 112, a central manipulation panel device 113, a medical controller (MC) 114, a recorder 115, a video processor 116, an endoscope light source device 117, an insufflation unit 118, and an electrical surgical device 119 are arranged.

The central manipulation panel device 113 is arranged in an unsterilized area to be used by nurses or the like in order to manipulate the respective medical devices in a centralized manner. This central manipulation panel device 113 may include a pointing device such as a mouse, a touch panel, or the like (not shown). By using the central manipulation panel device 113, the medical devices can be managed, controlled, and manipulated in a centralized manner.

The respective medical devices are connected to the MC 114 via communication cables (not shown) such as serial interface cables or the like, and can have communications with one another.

Also, a headset-type microphone 142 can be connected to the MC 114. The MC 114 can recognize voices input through the headset-type microphone 142, and can control the respective devices in accordance with the voices of the operating person.

The endoscope light source device 117 is connected to a first endoscope 146 through a light-guide cable used for transmitting the illumination light. The illumination light emitted from the endoscope light source device 117 is provided to the light guide of the first endoscope 146 and illuminates the affected areas or the like in the abdomen of the patient 145 into which the insertion unit of the first endoscope 146 has been inserted.

The optical image data obtained through the camera head of the first endoscope 146 is transmitted to a video processor 116 through a camera cable. The optical image data undergoes signal processing in a signal processing circuit in the video processor 116, and the video signals are created.

The insufflation unit 118 provides CO₂ gas to the abdomen of the patient 145 through a tube. The CO₂ gas is obtained from a gas tank 121.

On the second trolley 139, an endoscope image display panel 131, a central display panel 132, a expansion unit 133, a recorder 134, a video processor 135, an endoscope light source device 136, and other medical devices 137 and 138 (such as an ultrasonic processing device, a lithotripsy device, a pump, a shaver, and the like) are arranged. These respective devices are connected to the expansion unit 133 through cables (not shown), and can communicate with one another. The MC 114 and the expansion unit 133 are connected to each other through the expansion cable 141.

The endoscope light source device 136 is connected to a second endoscope 147 through the light-guide cable for transmitting the illumination light. The illumination light emitted from the endoscope light source device 136 is provided to the light guide of the second endoscope 147, and illuminates the affected areas or the like in the abdomen of the patient 145 into which the insertion unit of the second endoscope 147 has been inserted.

The optical image data obtained through the camera head of the second endoscope 147 is transmitted to a video processor 135 through a camera cable. The optical image data undergoes signal processing in a signal processing circuit in the video processor 135, and the video signals are created. Then, the video signals are output to the endoscope image display panel 131, and endoscope images of the affected areas or the like are displayed on the endoscope image display panel 131.

Further, the MC 114 can be controlled by the operating person manipulating the devices in the unsterilized area. Also, the first and second trolleys 120 and 139 can include other devices such as printers, ultrasonic observation devices, or the like.

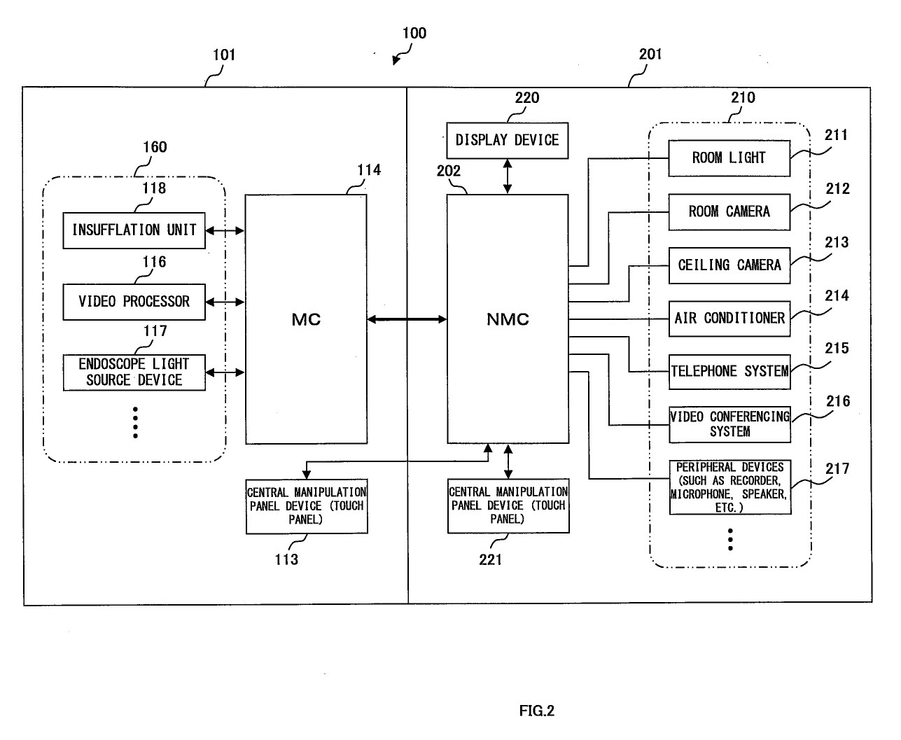

FIG. 2 is a block diagram showing an entire configuration of a medical support control system 100 according to the present embodiment. As described above, the medical support control system 100 includes the medical device control system 101 and a non-medical device control system 201. A detailed configuration of the medical device control system 101 is as shown in FIG. 1. However, in FIG. 2, the medical device control system 101 is shown in a simplified manner for simplicity of explanation.

In FIG. 2, a medical device group 160 is a group of medical devices that are directly connected to the medical controller 114 or are indirectly connected to the MC 114 via the expansion unit 133. Examples of the devices included in the medical device group 160 are the insufflation unit 118, the video processor 116, the endoscope light source device 117, the electrical surgical device 119, and the like.

The central manipulation panel device 113 has a touch panel, and in accordance with the information input into the touch panel, the devices connected to the MC 114 or a non-medical device controller (NMC) 202 that will be described later can be manipulated.

The non-medical control system 201 includes the NMC 202 connected to the MC 114 through a communication cable or the like, and a non-medical device group 210. In this configuration, the NMC 202 can transmit and receive, through an image cable, the video signals to and from the medical device group 160 connected to the MC 114.

The NMC 202 controls the non-medical devices (including the audio-visual devices) connected thereto. As shown in FIG. 2, the non-medical device group 210 connected to the NMC 202 according to the present embodiment consists of a room light 211, a room camera 212, a ceiling camera 213, an air conditioner 214, a telephone system 215, a conference system 216 to be used for individuals in remote places (referred to as a video conference system hereinafter), and other peripheral devices 217. Further, a display device 220 and a central manipulation panel device 221 are connected to the NMC 202.

Also, the non-medical device group 210 includes equipment such as light devices provided in the operating room in addition to the AV devices used for recording and reproducing image data.

The display device 220 is a plasma display panel (PDP) or a liquid crystal display (LCD) device, and displays images of the predetermined device or images of the devices selected by nurses or the like through the central manipulation panel device 221. The room light 211 is a device that illuminates the operating room. The room camera 212 is used for shooting images of the situations in the operating room. The ceiling camera 213 is a camera suspended from the ceiling whose positions can be changed. The conference system 216 is a system that displays images and transmits voices of nurses or the like in the medical office or the nurse stations, and enables conversations with them. The peripheral devices 217 are, for example, a printer, a CD player, a DVD recorder, and the like. The central manipulation panel device 221 has a touch panel that is the same as that included in the central manipulation panel device 113, and controls the respective AV devices connected to the NMC 202. The central manipulation panel devices 113 and 221 are referred to as TPs hereinafter.

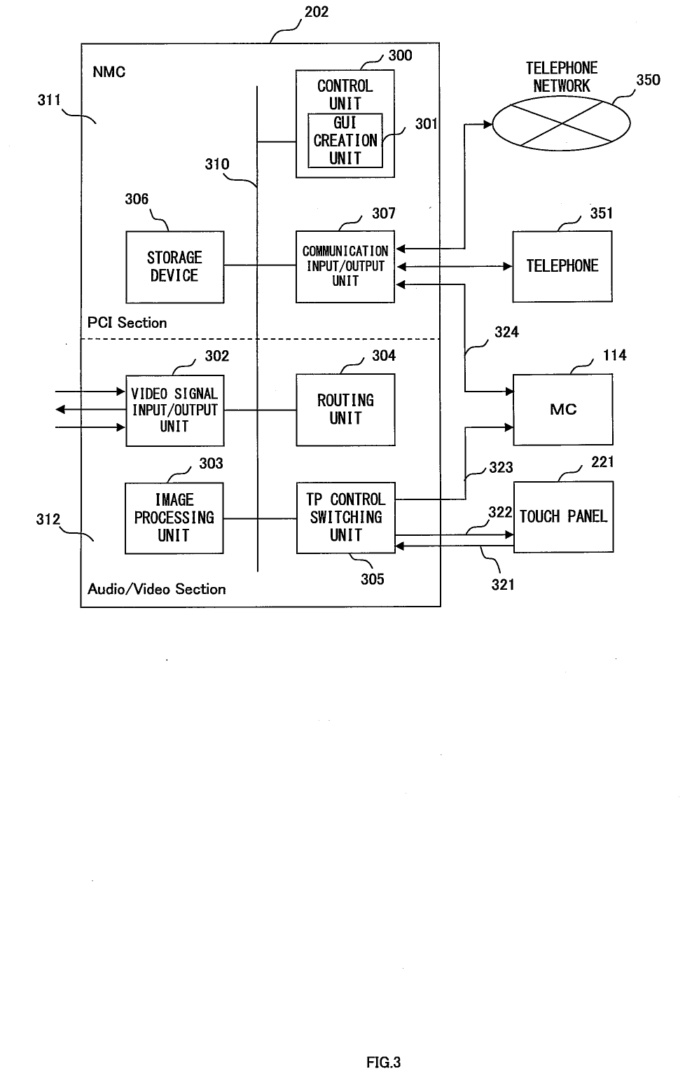

FIG. 3 is a block diagram showing a configuration of the NMC 202 in the present embodiment. The NMC 202 includes a PCI section 311 and an audio/video (A/V) section 312.

The PCI section 311 mainly controls a non-medical device group 210 connected to the NMC 202. The PCI section 311 includes a control unit 300, a storage device 306, and a communication input/output unit 307. The control unit 300 controls the entirety of the PCI section 311, and transmits and receives data to and from the A/V section 312. The control unit 300 has a GUI creation unit 301 and the like. Numerical symbol 310 denotes a back plane.

The GUI creation unit 301 creates Graphical User Interface image information (hereinafter referred to as GUI image information) that is an image layout to be displayed on a TP 221 or a monitor device, and transmits it to a routing unit 304

The storage device 306 stores various programs and information or the like set by the TP 221. The communication input/output unit 307 is a communication interface connected to a telephone circuit 350 and a communication network such as a Local Area Network (LAN) or the like so that they can be connected to a telephone 351 and to the MC 114 in order to perform communications. The NMC 202 and the MC 114 are connected to each other via a communication line 324.

The A/V section 312 is a section for mainly processing image signals and audio signals. The A/V section 312 has a video signal input/output unit 302, an image processing unit 303, a routing unit 304, and a TP control switching unit 305.

The video signal input/output unit 302 has a plurality of video signal input ports and a plurality of video signal output ports.

The routing unit 304 switches, in accordance with instructions given from the control unit 300, routes for the video signals input from the video signal input/output unit 302 and for the video signals processed in the image processing unit 303, and transfers them to a prescribed configuration unit. Also, the routing unit 304 transfers the GUI information created in the GUI creation unit 301 to the TP control switching unit 305.

The image processing unit performs image processing on the image information transferred from the routing unit 304. Examples of the image processing include the enlargement/reduction (scaling) of images, the mirroring of images, the rotation of images, displaying another, smaller image in a main image (picture in picture (PIP)), and displaying a plurality of images simultaneously (picture out picture (POP)).

The TP control switching unit 305 synthesizes the GUI image created in the GUI creation unit 301 with images created on the basis of the video signals transmitted from the video signal input/output unit 302. Then, the TP control switching unit 305 outputs the synthesized image to the TP 221 via an image output line 322. Further, the TP control switching unit 305 can perform switching between the NMC 202 and the MC 114 as the manipulation targets of the TP 221. In other words, the TP control switching unit 305 receives TP control information (coordinate information) based on touch manipulations from the TP 221 via a TP control signal line 321, transfers the received TP control information to the control unit 300, or transfers the TP control information to the MC 114 via a TP control signal line 323.

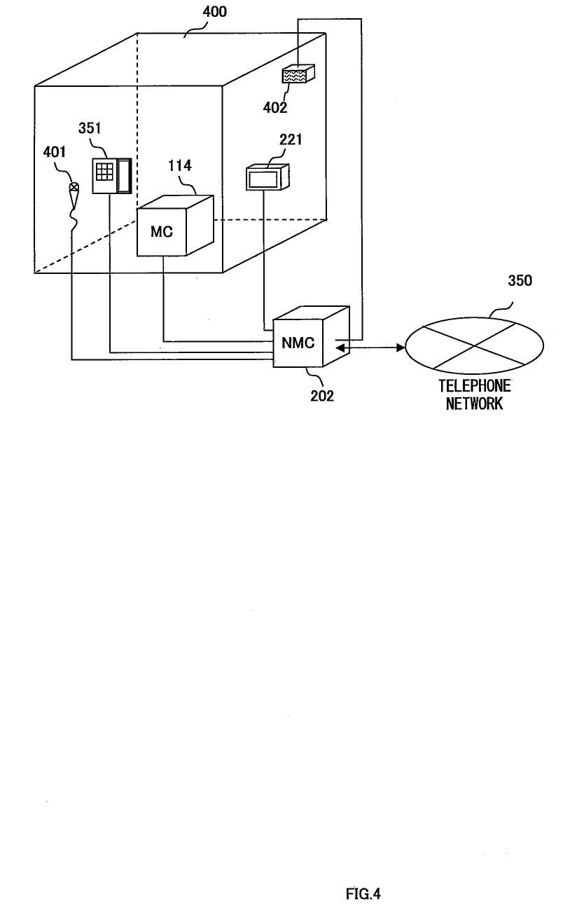

FIG. 4 shows an example of a setting environment for the MC 114 and the NMC 202 according to the present embodiment. The NMC 202 is provided in a place out of an operation room 400, and is connected to the telephone circuit 350 in the present embodiment.

The MC 114 is provided in the operation room 400. Also, the operation room 400 has a microphone 401, a speaker device 402, a telephone 351, and the TP 221 that are connected to the NMC 202.

Also, the location for the NMC 202 is not limited to a place outside of the operation room 400, but may be located in the operation room 400.

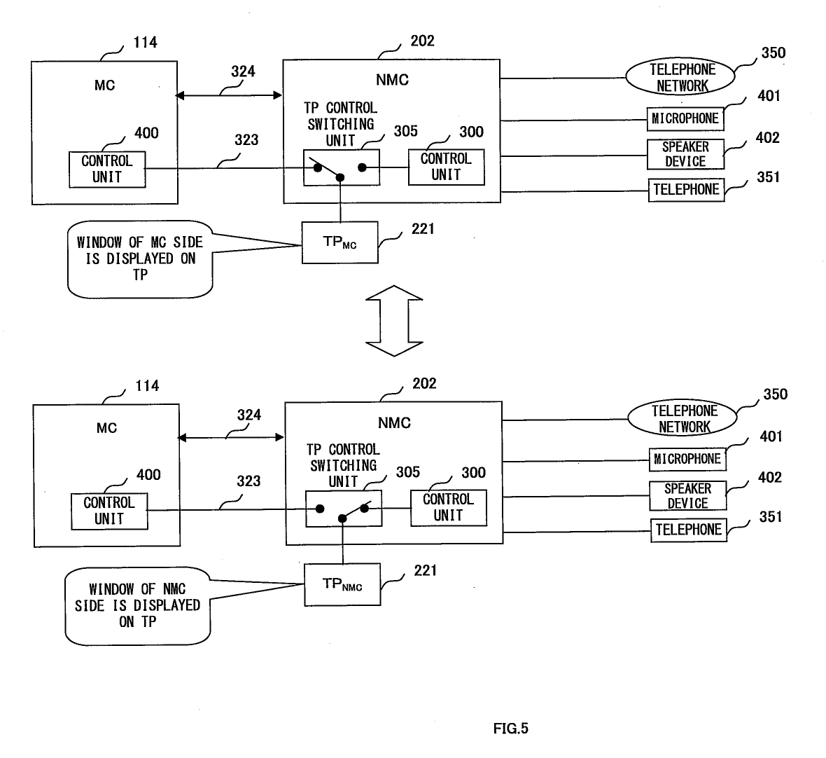

FIG. 5 shows switching operation of the control target of the TP control switching unit 305 performed between the NMC 202 and the MC 114.

As described above, the MC 114 is a controller mainly for medical devices. The MC 114 creates a graphical user interface (first GUI) that is a window used for controlling the medical devices belonging to the MC 114 itself.

As described above, the NMC 202 is a controller mainly for non-medical devices. The NMC 202 creates a graphical user interface (second GUI) that is a window used for controlling the non-medical devices belonging to the NMC 202 itself.

The first and second GUIs are designed on the basis of a common graphical user interface (common GUI). For example, by switching the tabs in a window, the first and second GUIs can be switched therebetween. This operation will be explained later in detail.

The MC 114 and the NMC 202 are connected to each other via the communication line 324 used for transmitting and receiving data to and from each other and via the TP control signal line 323 used for manipulating the MC 114 by using the TP 221 via the NMC 202.

When the first GUI is displayed on the TP 221, if the second GUI is to be opened via touch manipulation, a control signal (TP control signal) activated via touch manipulation is transmitted to the control unit 400 of the MC 114. The control unit 400, having received the TP control signal, reports, to the control unit 300 of the NMC 202, the fact that the first GUI is switched to the second GUI via a communication line 324. The control unit 300, having received this report, controls the TP control switching unit 305, and switches the TP control signal line from the MC 114 side to the NMC 202 side. Then, the control unit 300 causes the TP 221 to display the second GUI. Also, the same operation is performed if the first GUI is opened by touch manipulation when the second GUI is displayed on the TP 221.

As described above, the control unit 300 and the control unit 400 communicate with and monitor each other via the communication line 324. Also, the control unit 300 and the control unit 400 synchronize each other's GUI environment via the communication line 324, and exchange information to be held in common for configuring a common GUI (for example, constituent elements (window item information such as tab name or the like) for windows to be used in common).

In FIG. 5, when switching is performed for the MC 114 side by the TP control switching unit 305 (upper view), a window controlled by the MC 114 is displayed on the TP 221. Then, a touch signal of the TP 221 is transmitted to the control unit 400 of the MC 114 via the TP control switching unit 305 and the TP control signal line 323. In this case, the TP 221 displays the first GUI created by the MC 114, and by using this first GUI, MC 114 can be controlled. The touch panel in the case when the MC 114 is controlled by using the first GUI is denoted by TP_{MC}.

In FIG. 5, when switching is performed for the NMC 202 side by the TP control switching unit 305 (lower view), a window controlled by the NMC 202 is displayed on the TP 221. Then, the TP control signal created by manipulating the TP 221 is transmitted to the control unit 300 of the NMC 202 via the TP control switching unit 305. In this case, the second GUI created by the NMC 202 is displayed, and by using this GUI, the NMC 202 can be controlled. The touch panel in the case when the NMC 202 is controlled by using the second GUI is denoted by TP_{NMC}.

By employing the above configuration, the target controlled by the TP 221 is switched between the MC 114 and the NMC 202 by using the TP control switching unit 305. However, this switching is not perceived by users, and accordingly users feel as if they have controlled only one controller.

As described above, the TP 221 connected to the NMC 202 is shared by the MC 114 and the NMC 202. Also, the first GUI created in the MC 114 and the second GUI created in the NMC 202 are displayed in the common GUI format on the TP 221.

When the first GUI is displayed on the TP 221 in the present embodiment, if the NMC 202 receives a call via the telephone circuit 350, a symbol indicating that there is a telephone call is displayed on the TP 221. When this symbol is selected and pressed, the window is switched to a telephone conversation window of the second GUI, and the telephone conversation is enabled via the NMC 202.

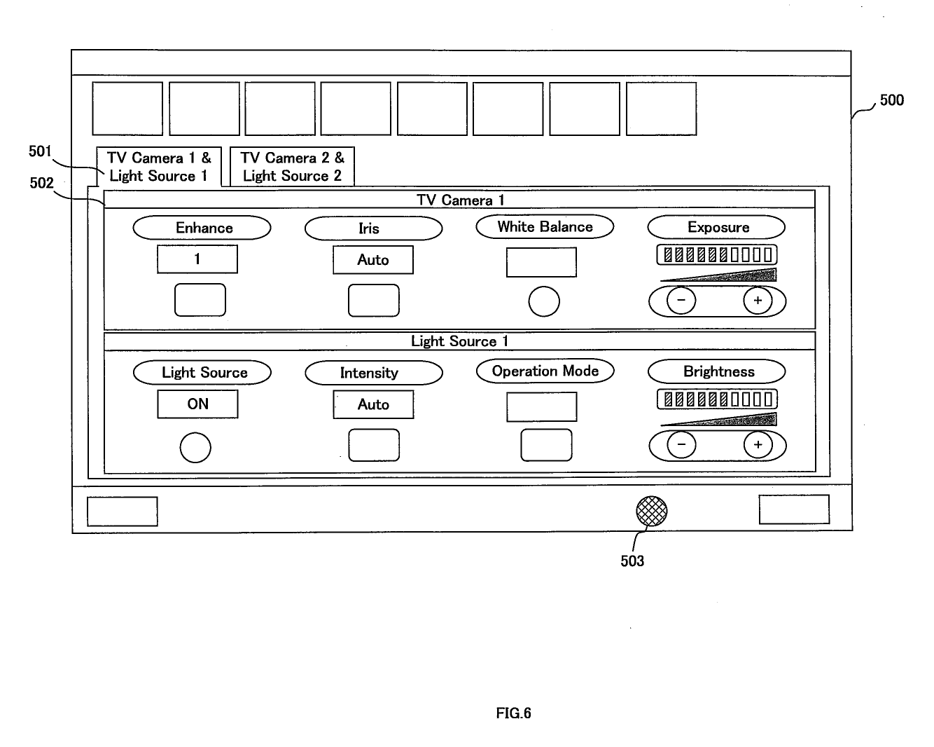

FIG. 6 shows an example of a display window (first GUI) of the touch panel (TP_{MC}) when the MC 114 side is the control target. In a window 500, shown in FIG. 6, a tab “TV Camera 1 and Light Source 1” 501 is selected as an example, and a selection tab display area 502 is displayed. Thus, on the selection tab display area 502, it is possible to adjust “TV camera 1” and “Light Source 1”.

Also, in a lower portion of the window 500, a prescribed symbol 503 is displayed. This symbol 503 is not usually displayed in a window. When there is a phone call to the NMC 202, the symbol 503 is displayed, and it is possible to report, to the users viewing the TP 221, the fact that there is a telephone call to the NMC 202. Also, the symbol 503 is not limited as long as it can visually report to the users the fact of a telephone call. Also, the symbol 503 may be displayed on the TP 221 in an emphasized manner such as by flashing or by being enlarged or reduced. Also, the symbol 503 may be arranged at any position in the window.

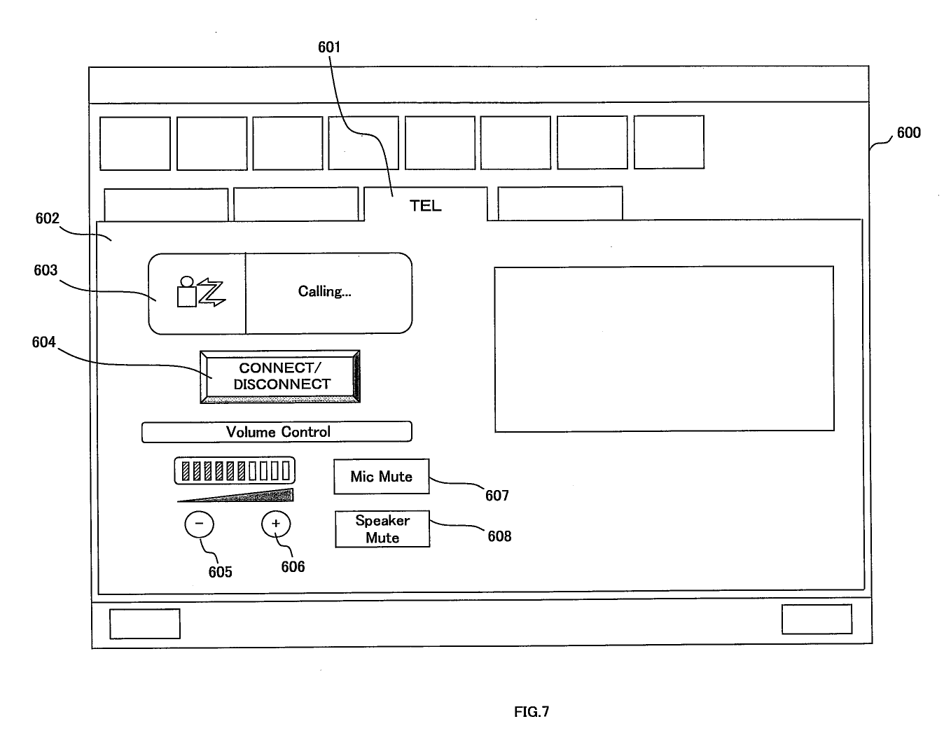

FIG. 7 shows an example of a telephone conversation window (second GUI) of the touch panel (TP_{NMC}) displayed when the NMC 202 side is the control target. In a window 600, shown in FIG. 7, a tab “TEL” 601 is selected as an example, and a selection tab detailed display area 602 is displayed.

The selection tab detailed display area 602 has a telephone conversation state display area 603, a connection/disconnection button 604, volume control buttons 605 and 606, a microphone mute button 607, and a speaker mute button 608.

On the telephone conversation state display area 603, telephone conversation states such as “calling”, “during conversation”, or “conversation is ended” are displayed. When the connection/disconnection button 604 is pressed during a conversation, the connection can be disconnected. When the connection/disconnection button 604 is pressed when the line is not connected, it is possible to make a call.

When the volume control button 605 is pressed, the volume of the voices output from the speaker device 402 can be reduced. When the volume control button 606 is pressed, the volume of the voices output from the speaker device 402 can be increased. When the microphone mute button 607 is pressed, it is possible to mute the voices to be input into the microphone 401. When the speaker mute button 608 is pressed, it is possible to mute the voices output from the speaker device 402.

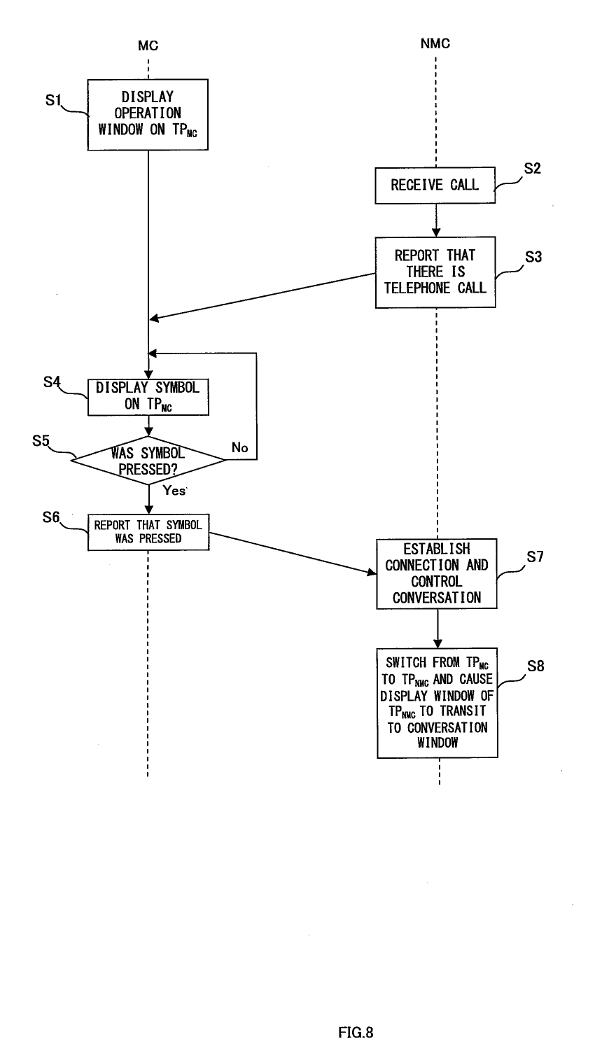

FIG. 8 is a flowchart for switching the control target between the MC 202 and the MC 114, performed by the TP control switching unit 305. First, a window controlled by the MC 114 is displayed on the TP_{MC} (as in FIG. 6) (S1). In this case, the TP control switching unit 305 is in the state shown in the upper view of FIG. 5.

When there is a telephone call to the NMC 202 from an external environment in the above case (S2), the control unit 300 reports this fact to the MC 114 via the communication line 324 (S3).

The controller 400 of the MC 114, having received this report from the NMC 202, displays the symbol 503 on a lower portion of the TP_{MC} (S4). When the symbol 503 is pressed as one of the touch manipulations by the users (“Yes” in S5), the control unit 400 reports this fact to the NMC 202 via the communication line 324 (S6).

The control unit 300, having received the report from the MC 114, establishes the connection for the call and performs control for enabling the conversation (S7). Then, the TP control switching unit 305 switches the target controlled by the TP 221 from the MC 114 to the NMC 202 according to an instruction of the control unit 300. In this case, the TP control switching unit 305 is in the state shown in the lower view in FIG. 5. Further, the NMC 202 causes the TP_{NMC} to display the conversation window (FIG. 7). Then, the user can have a conversation via the microphone 401 and the speaker device 402.

In the conventional techniques, it has been impossible to answer a call when a window created in the MC 114 is being displayed on the TP 221. However, according to the present embodiment, it is possible to answer a call by pressing the symbol 503 on the TP 221 even when a window created by the MC 114 is being displayed on the TP 221.

When an e-mail is received from a network to which the NMC 202 is connected while the GUI on the MC 114 side is being displayed on the TP 221, it is impossible to open the e-mail immediately. The present invention enables users to open the e-mail even in such cases.

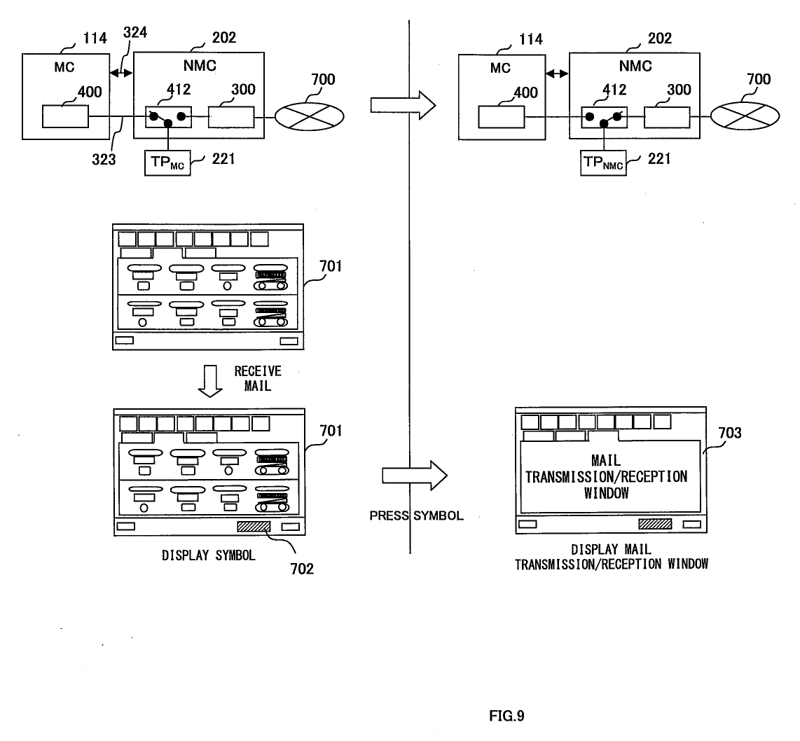

FIG. 9 shows a switching operation from a window of the MC 114 side to a window of the NMC 202 side performed when e-mails are received while the window of the MC 114 side is being displayed according to the present embodiment (variation 1). In the variation 1, the NMC 202 is connected to a network 700 such as a local area network (LAN), a wide area network (WAN), the Internet, an intranet, or the like.

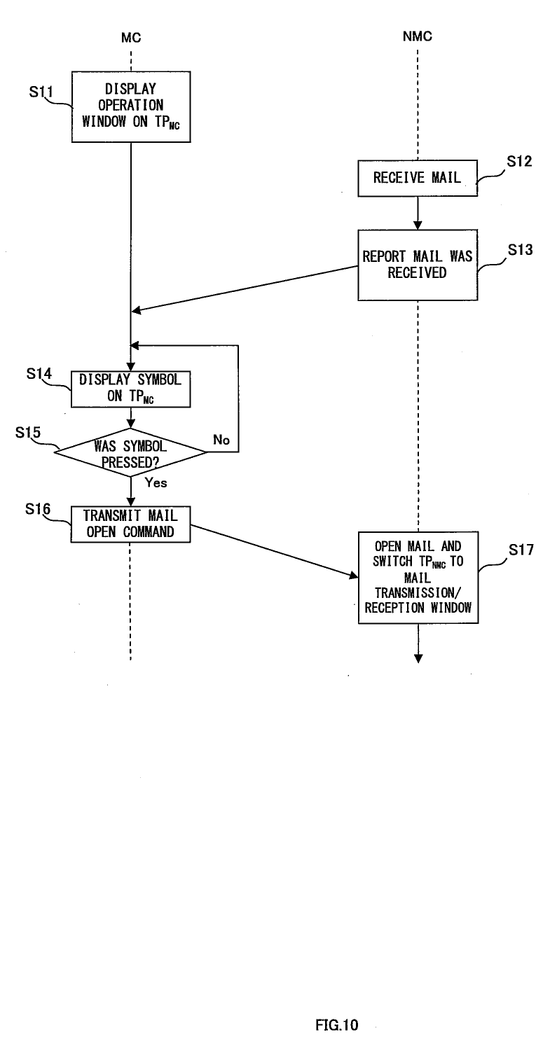

FIG. 10 is a flowchart for switching a control target between the NMC 202 and the MC 114 performed by the TP control switching unit 305 according to the present embodiment (variation 1). Hereinafter, explanations will be given by referring to FIGS. 9 and 10.

First, a window 701 to be controlled by the MC 114 is displayed on the TP_{MC} (S11). The NMC 202 receives an e-mail via the network 700 (S12). Then, the control unit 300 reports to the MC 114 via the communication line 324 the fact that an e-mail has been received (S13).

The control unit 400, having received the report from the NMC 202, displays a “mail” button 702 as a symbol in the lower part of a window TP_{MC} (S14). When the “mail” button 702 is pressed as one of the user's manipulations (Yes in S15), the control unit 400 transmits a mail open command to the NMC 202 via the communication line 324 (S16).

The TP control switching unit 305, having received the command from the MC 114, switches the target to be controlled by the TP 221 from the MC 114 to the NMC 202. Further, the NMC 202 causes the TP_{NMC} to display a mail transmission/reception window 703, and opens the received e-mail (S17).

Thereby, when the NMC 202 has received an e-mail, it is possible to open the e-mail even when the GUI of the MC 114 side is being displayed on the TP 221.

Also, when there is no more free space in a storage medium (such as video tape, a DVD, a Blu-ray disk, an HD DVD, flash memory, a hard disk, or the like) used for recording an image while a GUI of the MC 114 side is being displayed on the TP 221, it is impossible to replace the storage medium with a new one immediately. It is desired that storage media be able to be replaced in such a case too.

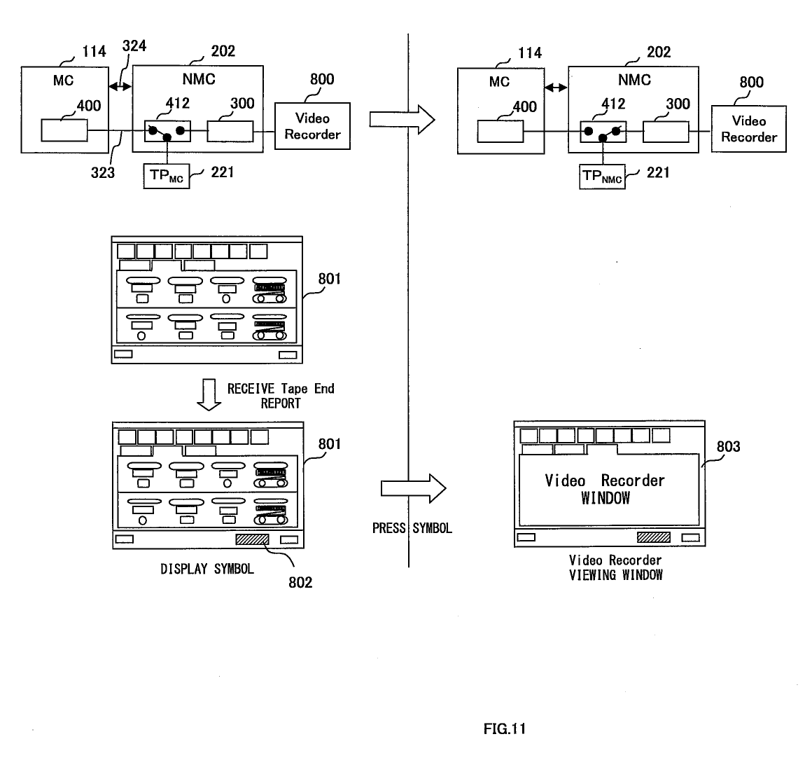

FIG. 11 shows the switching to a window of the NMC 202 side performed when there is no more free space in a storage medium while a window of the MC 114 side is being displayed according to the present embodiment (variation 2). In variation 2, a video recorder 800 is connected to the NMC 202.

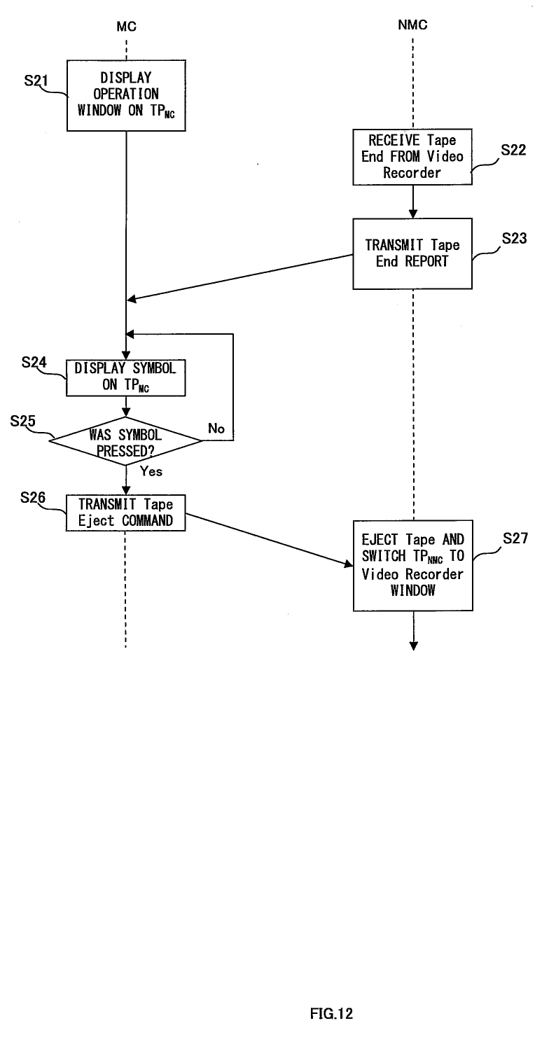

FIG. 12 is a flowchart for switching a control target between the NMC 202 and the MC 114, performed by the TP control switching unit 305 according to the present embodiment (variation 2). Hereinafter, explanations will be given by referring to FIGS. 11 and 12. In the example below, tape is used as a storage medium; however, any type of storage medium including a DVD, a Blu-ray disk, an HD DVD, flash memory, a hard disk, or the like can be used.

First, a window 801 to be controlled by the MC 114 is displayed on the TP_{MC} (S21). The NMC 202 receives from the video recorder 800 a report indicating that the tape has reached its end (a tape-end report) (S22) Then, the control unit 300 transmits to the MC 114 via the communication line 324 the tape-end report (S23).

The control unit 400, having received the report from the NMC 202, displays a “Tape End” button 802 as a symbol in a lower part of the window of the TP_{MC} (S84). When the “Tape End” button 802 is pressed as one of the user's manipulations (Yes in S25), the control unit 400 transmits to the NMC 202 via the communication line 324 a tape-eject command (S26).

The control unit 300, having received the command from the MC 114, causes the video recorder 800 to eject the video tape. The TP control switching unit 305 switches the target to be controlled by the TP 221 from the MC 114 to the NMC 202. Then, the NMC 202 causes the TP_{NMC} to display a video recorder window 803 (S27).

Thereby, when there is no more free space in a storage medium while an image is being recorded in the storage medium using a video recorder connected to the NMC 202, it is possible to easily replace the storage medium with a new one even when a GUI of the MC 114 side is being displayed on the TP 221. Also, an example of a video recorder is used in variation 2; however, variation 2 can be applied to other devices. Further, in variation 2, events such as displaying a symbol or switching controllers occur in response to the report indicating that there is no more free space in a storage medium; however, events such as displaying a symbol or switching controllers or the like can occur in response to errors in devices or a warning message transmitted from devices.

According to the present embodiment, the medical support control system includes a first controller (MC 114), a second controller (NMC 202), and a manipulation display device (TP 221). The first controller is connected to at least one device. The second controller is connected to at least one device and to a network, and is provided in a medical environment different from that of the first controller. On the manipulation display device, a first graphical user interface (first GUI) that is shared by the first and second controllers and is created by the first controller and a second graphical user interface (second GUI) created by the second controller are displayed alternately. The second controller has a switching unit for switching the GUI to be displayed on the manipulation display device between the first and second GUIs. The switching unit switches the GUI to be displayed on the manipulation display device from the first GUI to the second GUI on the basis of the report from the first controller indicating that the symbol has been pressed.

When a prescribed report is received via the network or from the prescribed device while the first GUI is being displayed on the manipulation display device, a symbol indicating the reception of the report is displayed on the first GUI. When the symbol is pressed, the second GUI corresponding to the report is displayed. Also, a process corresponding to the report is performed by the second controller.

By this configuration, even when the subject of controlling the medical support control system is the first controller, if a prescribed event occurs, it is possible to report to the users the occurrence of the event and to switch the controlling subject to the second controller.

According to one example of the present embodiment, the network is a telephone circuit. When there is a telephone call via the telephone circuit while the first GUI is being displayed on the manipulation display device, a symbol indicating that there is a telephone call is displayed on the first GUI. When the symbol is pressed, the conversation window of the second GUI is opened. Also, the conversation is enabled via the second controller.

By the above configuration, even when a window created by the MC 114 is being displayed on the TP 221, it is possible to answer a call by pressing the symbol 503 displayed on the TP 221.

Also, according to one example of the present embodiment, when an e-mail is received via the network while the first GUI is being displayed on the manipulation display device, a symbol indicating that the e-mail has been received is displayed on the first GUI. When this symbol is pressed, an e-mail transmission/reception window of the second GUI is opened. Also, the received e-mail is displayed in the e-mail transmission/reception window.

By the above configuration, when the NMC 202 has received an e-mail, the e-mail can be opened even when the GUI of the MC 114 side is being displayed on the TP 221.

Also, according to one example of the present embodiment, the prescribed device is a video recorder. When a report is received indicating that there is no more free space in a storage medium from the video recorder while the first GUI is being displayed on the manipulation display device, a symbol indicating the reception of such a report is displayed on the first GUI. When this symbol is pressed, a video recorder manipulation window of the second GUI corresponding to the report is opened. Also, the second controller causes the video recorder to replace the storage medium with a new one.

By the above configuration, even when there is no more free space in a storage medium that is recording an image by using a video recorder connected to the NMC 202, it is possible to easily replace the storage medium with a new one even if the GUI of the MC 114 side is being displayed on the TP 221.

The scope of the present invention is not limited to the above embodiments, and various alterations and modifications are allowed without departing from the spirit of the present invention.

As described above, it is possible to provide a medical support control system that controls a medical device and a non-medical device.

What is claimed is:

1. A medical support control system, comprising:
a first controller connected to at least one device;
a second controller connected to at least one device, connected to a network, and provided in a medical environment different from that of the first controller; and
a manipulation display device shared by the first and second controllers and alternately displaying a first graphical user interface (first GUI) created by the first controller and a second graphical user interface (second GUI) created by the second controller, wherein:
if a prescribed report is received via the network or from the prescribed connected device while the first GUI is being displayed on the manipulation display device, a symbol indicating that the report has been received is displayed on the first GUI, and when the symbol is pressed, the first GUI is switched to a prescribed window of the second GUI corresponding to the report, and a process corresponding to the report is performed by the second controller.

2. The medical support control system according to claim 1, wherein:
the network is a telephone circuit; and
when there is a telephone call via the telephone circuit while the first GUI is being displayed on the manipulation display device, a symbol indicating that there is a telephone call is displayed on the first GUI, and when the symbol is pressed, the first GUI is switched to a conversation window of the second GUI, and a conversation via the second controller is enabled.

3. The medical support control system according to claim 1, wherein:
when an e-mail has been received via the network while the first GUI is being displayed on the manipulation display device, a symbol indicating that the e-mail has been received is displayed on the first GUI, and when the symbol is pressed, the first GUI is switched to an e-mail transmission/reception window of the second GUI, and the received e-mail is displayed in the e-mail transmission/reception window by the second controller.

4. The medical support control system according to claim 1, wherein:
the prescribed device is a video recorder; and
when a report indicating that there is no more free space in a storage medium is received from the video recorder while the first GUI is being displayed on the manipulation display device, a symbol indicating reception of the report is displayed on the first GUI, and when the symbol is pressed, the first GUI is switched to a video recorder manipulation window of the second GUI, and the second controller causes the video recorder to perform operations for replacing the storage medium with a new one.

5. The medical support control system according to claim 1, wherein:
the second controller has a switching unit for switching a GUI to be displayed on the manipulation display device between the first GUI and the second GUI; and
the switching unit switches a GUI to be displayed on the manipulation display device from the first GUI to the second GUI in accordance with a report from the first controller indicating that the symbol was pressed.
